(19) United States
(12) Patent Application Publication
(10) Pub. No.: US 2011/0010582 A1
(43) Pub. Date: Jan. 13, 2011

(54) STORAGE SYSTEM, EVACUATION PROCESSING DEVICE AND METHOD OF CONTROLLING EVACUATION PROCESSING DEVICE

(75) Inventors: Nina TSUKAMOTO, Kawasaki (JP); Sadayuki OHYAMA, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/822,571

(22) Filed: Jun. 24, 2010

(30) Foreign Application Priority Data
Jul. 9, 2009 (JP) 2009-16372

(51) Int. Cl. G06F 11/20

(52) U.S. Cl. 714/14; 714/E11.083

(57) ABSTRACT

A storage system has a first power supply unit, a second power supply unit for supplying electronic power to the storage system when the first power supply unit is not supplying electronic power to the storage system, a storage for storing data, a first memory for storing data, a control unit for reading out data stored in the storage and writing the data into the first memory, and reading out data stored in the first memory and writing the data into the storage, a second memory for storing cache data, a table indicating whether each of the data stored in the first memory is to be evacuated to the second memory or not, respectively, and an evacuating unit for evacuating the data stored in the first memory to the second memory in reference to the table when the second power supply unit is supplying electronic power to the storage system.

### CROSS-REFERENCE TO RELATED APPLICATION

This application is based upon and claims the benefit of priority of the prior Japanese Patent Application No. 2009-163172, filed on Jul. 9, 2009, the entire contents of which are incorporated herein by reference.

### FIELD

The present art relates to an evacuation processing device which reduces processing time required for a backup process which follows, e.g., a power failure of a RAID device.

### BACKGROUND

A RAID (Redundant Arrays of Independent (Inexpensive) Disks) mechanism is widely known as an art of combining a plurality of HDDs (Hard Disk Drives) so as to build a disk system of high speed, large capacity and high performance features.

In general, a RAID device reads and writes user data by using a cache memory so as to reduce a processing time required for data access from an upper device (e.g., a host computer, called the host hereafter).

A semiconductor memory device such as a DRAM (Dynamic Random Access Memory) or an SRAM (Static Random Access Memory) is ordinarily used as the cache memory.

Upon being requested by the host to read user data, the RAID device searches the cache memory (simply called the cache hereafter) for the user data. Upon obtaining the user data corresponding to the reading request, the RAID device notifies the host of the obtained cache data.

Meanwhile, unless obtaining the user data from the cache, the RAID device obtains user data stored in a hard disk device (simply called the disk hereafter) and writes the obtained user data to the cache.

Further, upon receiving a writing request of user data, the RAID device notifies the host at a time of storing the user data in the cache that the writing process has finished. Afterwards, at a time when particular conditions are fulfilled, the RAID device stores the cached user data in the disk.

Incidentally, as a volatile semiconductor device is used as the cache described above, cached user data is erased if the cache is powered off. Thus, in case of a power failure, it is necessary to evacuate all data stored in the cache to a nonvolatile memory device (e.g., a NAND flash, a CompactFlash (registered trademark), etc.) so as to back it up.

Incidentally, an art of performing a write-back (to write write-data to a hard disk) process efficiently and saving power in case of a power failure, and an art of reallocating a logical disk device to a physical disk device on the basis of access information of the disk are known, as disclosed in Japanese Laid-open Patent Publication No. 09-330277 and No. 2006-59374, respectively.

According to the ordinary arts described above, however, as all the cache data is made an object to be backed up, the backup process spends more than necessary time in some cases.

In circumstances where huge cache data 24a is stored in the cache 24 illustrated in FIG. 12 and in case of a power failure in the RAID device 20, the backup process spends more than necessary time in some cases.

In such a case, the RAID device 20 can possibly fail to evacuate all the cache data 24a to the NAND flash 23 while the SCU 27 supplies power and some of the cache data can possibly be lost in some cases.

### SUMMARY

According to an aspect of an embodiment, a storage system has a first power supply unit for supplying electronic power to the storage system, a second power supply unit for supplying electronic power to the storage system when the first power supply unit is not supplying electronic power to the storage system, a storage for storing data, a first memory for storing data, a control unit for reading out data stored in the storage and writing the data into the first memory, and reading out data stored in the first memory and writing the data into the storage, a second memory for storing data stored in the first memory, a table memory for storing a table indicating whether each of the data stored in the first memory is to be evacuated to the second memory or not, respectively, and an evacuating unit for evacuating the data stored in the first memory to the second memory in reference to the table when the second power supply unit is supplying electronic power to the storage system.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram for illustrating a configuration of an evacuation processing device of a first embodiment;

FIG. 2 is a functional block diagram for illustrating a configuration of a RAID device of a second embodiment;

FIG. 3 illustrates an example of a data structure in a NAND flash of the second embodiment;

FIG. 4 illustrates an example of a data structure in a cache memory of the second embodiment;

FIG. 5 is a functional block diagram for illustrating a configuration of an FPGA of the second embodiment;

FIG. 6 illustrates an example of a data structure in a Skip management table of the second embodiment;

FIG. 7 illustrates an example of a data structure in a TBM of the second embodiment;

FIG. 8 illustrates a backup process;

FIG. 9 illustrates a process of an RoC of the second embodiment;

FIG. 10 is a flowchart for illustrating a process in case of a power failure;

FIG. 11 is a flowchart for illustrating a process of the RAID device of the second embodiment; and

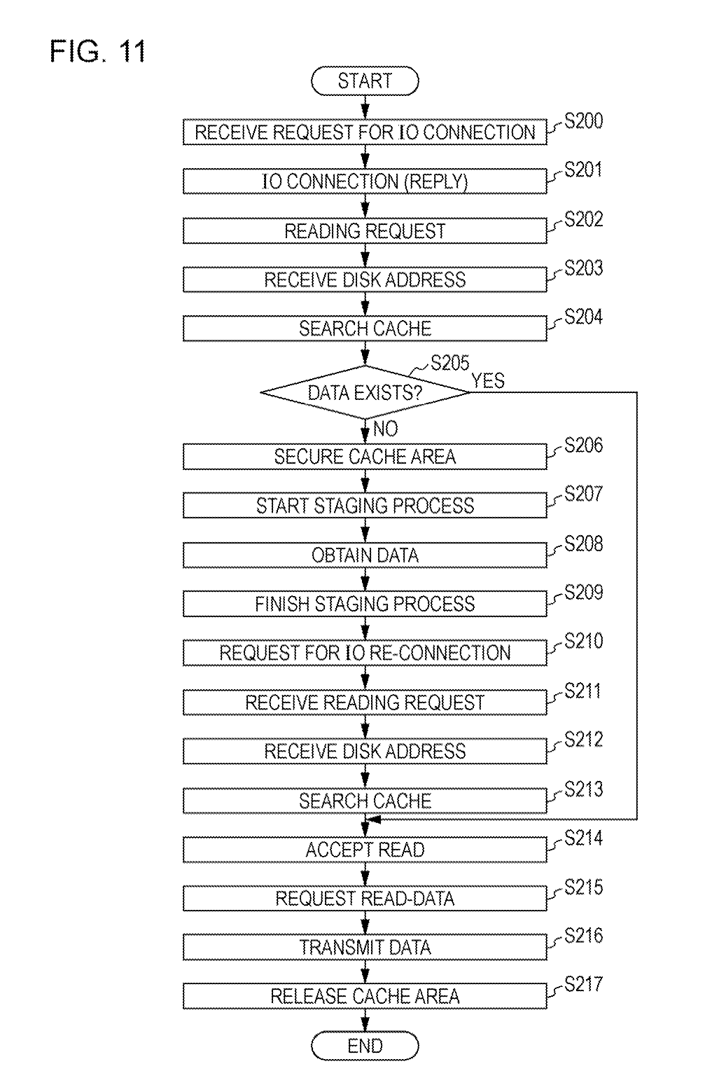

FIG. 12 illustrates an ordinary art.

### DESCRIPTION OF EMBODIMENTS

Embodiments of an evacuation processing device, a method for evacuation processing and a storage system disclosed by the present art will be explained in detail with reference to the drawings. The present art is not limited to the embodiments.

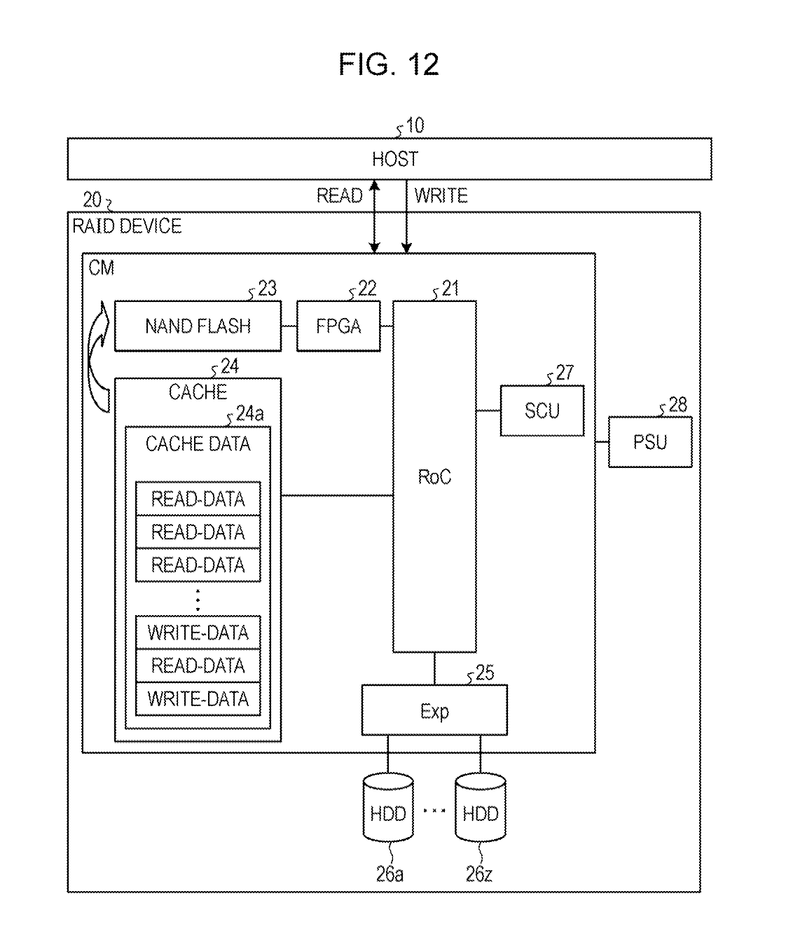

As illustrated in FIG. 12, e.g., a RAID device 20 evacuates cache data 24a stored in a cache 24 to a NAND flash 23 in case of a power failure without distinguishing read-data and write-data.

Further, in case of a power failure, the power supply to the RAID device 20 is switched from a PSU (Power Supply Unit) 28 to an SCU (Super Capacitor Unit) 27, so that the RAID device 20 performs the evacuation process described above by using the power stored in the SCU 27.

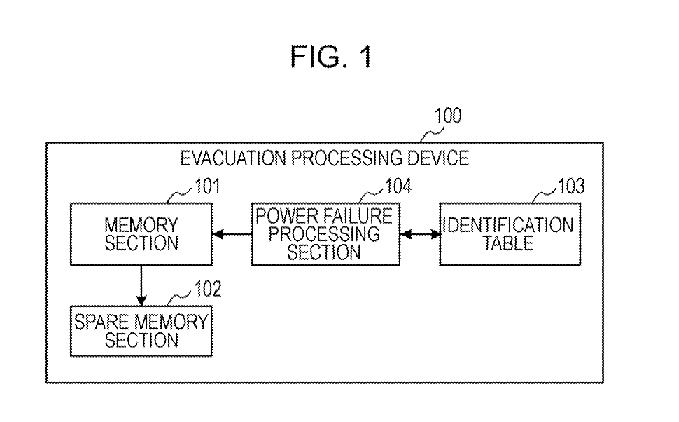

FIG. 1 is a functional block diagram for illustrating a configuration of an evacuation processing device of a first embodiment. The evacuation processing device 100 is a device which evacuates data required for a backup process in case of a power failure, and has a memory section 101, a spare memory section 102, an identification table 103 and a power failure processing section 104.

The memory section 101 is a memory section in which cache data to be used for data communication to and from an upper device is stored. The spare memory section 102 is a memory section in which the cache data stored in the memory section 101 is backed up in case of a power failure.

The identification table 103 manages portions of the cache data stored in the memory section 101 to be evacuated to the spare memory section 102 and not to be evacuated in case of a power failure.

The power failure processing section 104 is a processing section which evacuates the cache data from the memory section 101 to the spare memory section 102 on the basis of the identification table 103.

The evacuation processing device 100 illustrated as the first embodiment can reduce processing time required for backing a cache memory up in case of a power failure and increase a backup speed.

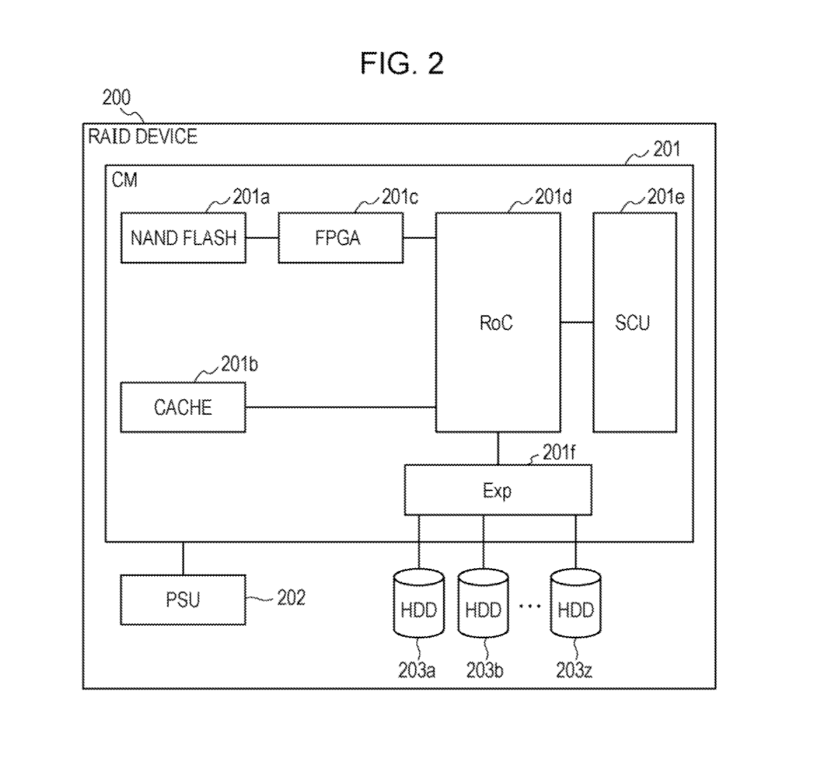

Then, a RAID (Redundant Arrays of Independent (Inexpensive) Disks) device illustrated as a second embodiment will be explained. FIG. 2 is a functional block diagram for illustrating a configuration of the RAID device of the second embodiment.

The RAID device 200 illustrated in FIG. 2 exchanges various user data and programs stored in HDDs (Hard Disk Drives) in response to requests from a plurality of upper devices (e.g., host computers A, B, C, . . . , simply called the host(s) hereafter). Moreover, the RAID device 200 evacuates cache data required for a backup process to a NAND-type memory in case of a power failure. A storage system has a first power supply unit for supplying electronic power to the storage system, a second power supply unit for supplying electronic power to the storage system when the first power supply unit is not supplying electronic power to the storage system, a storage for storing data, a first memory for storing data, a control unit for reading out data stored in the storage and writing the data into the first memory, and reading out data stored in the first memory and writing the data into the storage, and a second memory for storing data stored in the first memory.

The RAID device 200 has a CM (Controller Module) 201, a PSU (Power Supply Unit) 202 and the HDDs (Hard Disk Drives) 203a-203z.

The CM 201 is a controller which manages a cache memory, controls an interface with the host, and controls each of the HDDs. The CM 201 has a NAND flash 201a, a cache 201b, an FPGA (Field Programmable Gate Array) 201c, an RoC (RAID-on-Chip) 201d, an SCU (Super Capacitor Unit) 201e and an Exp (expander) 201f.

The NAND flash 201a is a NAND-type memory which backs up cache data stored in the cache 201b if a power failure occurs in the RAID device 200.

As being configured to be accessed on a block-by-block basis, the NAND flash 201a does not allow random access and cache data in the cache 201b is written in a sequential-write process.

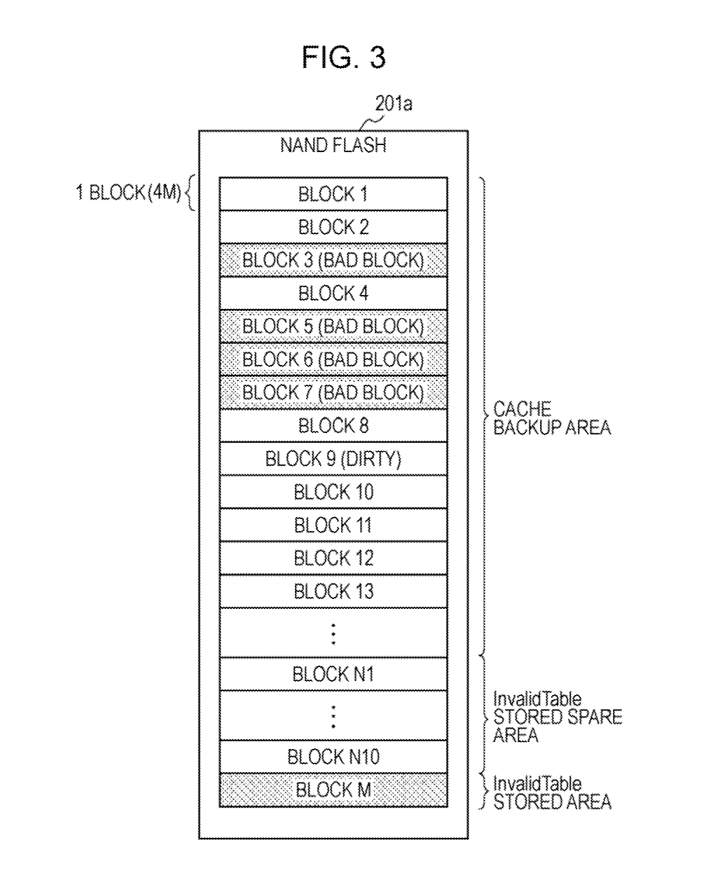

That will be specifically explained with reference to a drawing. FIG. 3 illustrates an example of a data structure in the NAND flash of the second embodiment. The NAND flash 201a has blocks 1-M in FIG. 3.

The block is a data area in which cache data is stored, and a physically divided unit of the NAND flash 201a. Cache data is written to each of the blocks. The data area for one block of the NAND flash 201a is 4 Mbytes in capacity which is convenient for the sequential-write process.

The block has a main area and a spare area. The main area is an area in which user data, etc. is stored. The spare area is an area in which data indicating ECC (error check and correct), a bad portion on delivery, etc. is stored.

The blocks 1-13 and 13-N1 illustrated in FIG. 3 are blocks to which cache data in the cache 201b is backed up. The blocks 3 and 5-7 among them are bad blocks, and the block 9 illustrates that user data in a Dirty state is backed up.

The “bad block” is a block to which cache data does not finish being written within a specified period of time because of exhaustion of the NAND flash 201a. The bad block is not used for backup of the cache data.

The term “Dirty” indicates a case where a transfer error of the cache data occurs during the backup and the process of writing data to the NAND flash 201a does not normally end. Assume that a cause of a transfer error depends, not upon a physical failure of the NAND flash 201a but, e.g., upon user data, differently from the bad block.

A block M is an area in which an InvalidTable is stored. In the “InvalidTable”, information indicating whether backed-up user data is “Dirty” or indicating a bad block that the NAND flash 201a has is stored, and the RoC 201d manages various data.

Further, the NAND flash 201a is provided with blocks N1-N10 as a spare area in which the InvalidTable is stored. A detailed data structure of the InvalidTable will be described later.

Then, the cache 201b illustrated in FIG. 2 will be explained. The cache 201b is a cache memory in which user data transferred between the host and the HDDs 203a-203z is temporarily stored. As described so far, the user data stored in the cache 201b is supposed to be cache data.

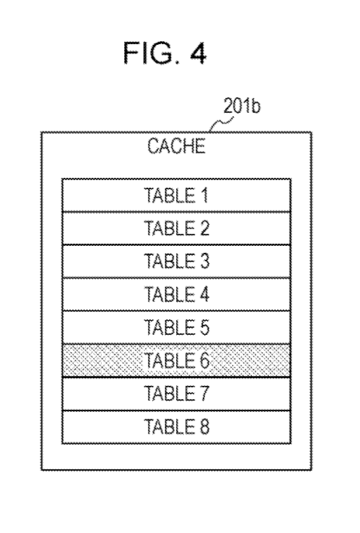

FIG. 4 illustrates an example of a data structure in the cache memory illustrated by the second embodiment. The cache memory 201b illustrated in FIG. 4 has a plurality of tables in which cache data is temporarily stored. A table memory stores a table indicating whether each of the data stored in the first memory is to be evacuated to the second memory or not, respectively

Each of the tables illustrated in FIG. 4 has a capacity for storing user data corresponding to 4 Mbytes. Further, the user data has a data length of 64 k and is managed by the RoC 201d.

Further, read-data and write-data are enumerated as an example of the user data. The “read-data” indicates user data already stored in the HDDs 203a-203z.

Thus, if the host requests the RAID device 200 to read user data, the CM 201 searches the cache 201b. Upon obtaining cache data corresponding to the reading request, the CM 201 provides the host with the obtained cache data.

Meanwhile, if the CM 201 does not obtain cache data from the cache 201b, the CM 201 obtains user data corresponding to the reading request from the HDD 203a, etc. and copies the obtained user data into the cache 201b. Such a process for obtaining user data corresponding to a reading request is called “staging” hereafter.

Meanwhile, the “write-data” is user data that the host requests the RAID device 200 to write, and is written to the respective HDDs upon meeting certain conditions. In particular, the write-data indicates user data stored in none of the HDDs 203a-203z. It is desirable to positively back the write-data up into the NAND flash 201a in case of a power failure.

In the cache 201b illustrated in FIG. 4, e.g., assume that write-data is stored in tables 1-5, 7 and 8, and read-data is stored in a table 6.

Return to the explanation referring to FIG. 2, and the FPGA 201c will be explained. The FPGA 201c indicates an integrated circuit controlled by a certain program, and has a DMA (Direct Memory Access) engine.

The DMA indicates a system for transferring data between a device and a RAM (Random Access Memory) not through a CPU (Central Processing Unit). The FPGA 201c of the embodiment is provided with a DMA to which a function required for evacuating cache data to the NAND flash 201a for restoration in case of a power failure is added.

A write-DMA (TRN) for evacuating cache data in case of a power failure, a read DMA (RCV) for returning the evacuated data to the cache 201b, and a command issuing DMA (UCE) for erasing or checking the NAND flash 201a are enumerated as exemplary DMAs. The DMA transfers data by means of hardware as directed by the RoC 201d.

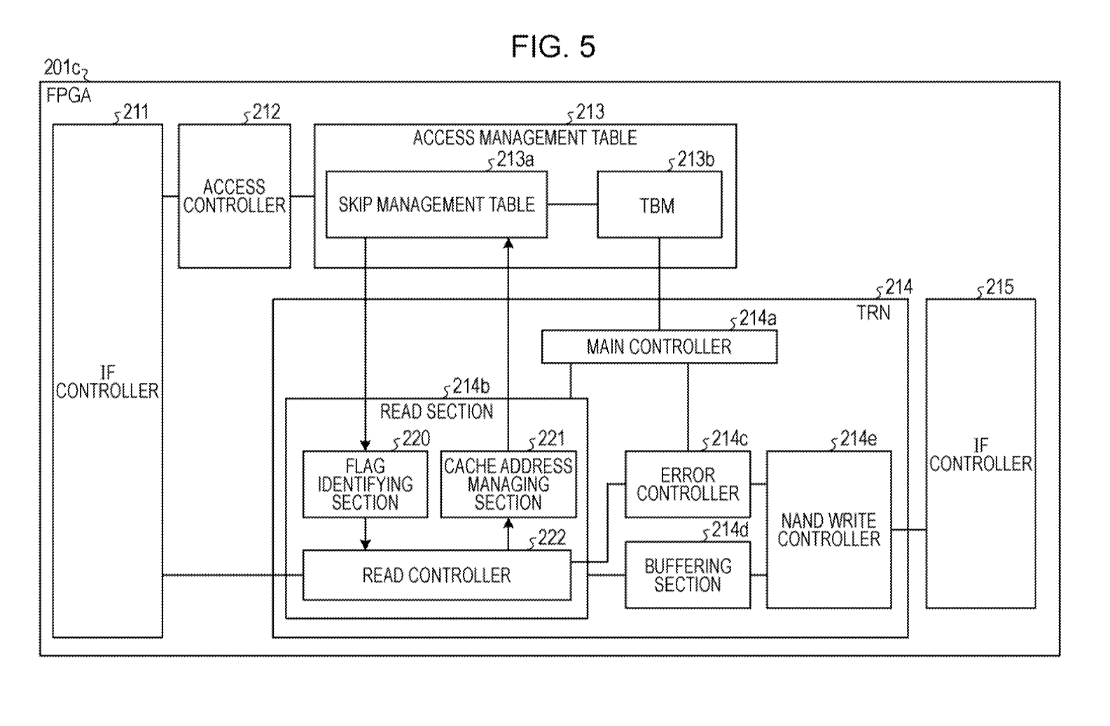

The FPGA 201c will be explained with reference to the drawing. FIG. 5 is a functional block diagram for illustrating a configuration of the FPGA illustrated by the second embodiment. The FPGA 201c evacuates certain data in the cache 201b to the NAND flash 201a in case of a power failure.

If the power supply is recovered, the FPGA 201c returns the data which has been evacuated to the NAND flash 201a to the cache 201b. The FPGA 201c has an IF (Interface) controller 211, an access controller 212, an access management table 213, a TRN 214 and an IF controller 215.

The IF controller 211 is an interface which controls an exchange of various data between the RoC 201d and the TRN 214 and an exchange of various data between the RoC 201d and the access controller 212.

The access controller 212 is a controller which controls an exchange of various data between the access management table 213a and the RoC 201d through the IF controller 211.

The access management table 213 has a Skip management table 213a and a TBM (bad block management table) 213b which manages the bad block described above. A data structure in the Skip management table 213a will be explained first.

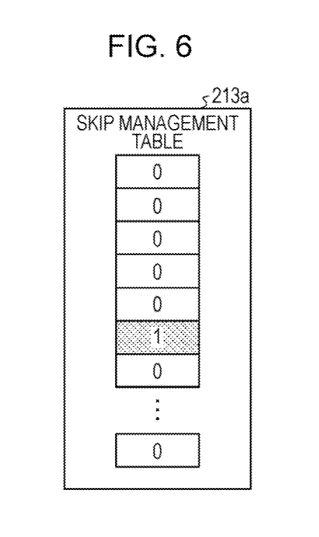

FIG. 6 illustrates an example of a data structure in the Skip management table 213a. The Skip management table 213a illustrated in FIG. 6 is a table in which a Skip flag indicating whether data is evacuated to the NAND flash 201a in case of a power failure is stored, and is managed by means of firmware of the RoC 201d.

As illustrated in FIG. 6, a value of 0 or 1 corresponds to the skip flag. In case of a power failure, cache data corresponding the skip flag being 0 is positively backed up in the NAND flash 201a, and cache data corresponding the skip flag being 1 is skipped and is not backed up in the NAND flash 201a.

Then, a correspondence relationship between the skip flag and cache data will be explained with reference to FIG. 4. A skip flag corresponding to the table 1 is “0” stored at a highest rank in the Skip management table 213a.

Skip flags stored in the Skip management table 213a similarly and individually correspond to the tables 2-8 in order. Thus, the skip flags of the tables 2-5, 7 and 8 are “0”, and the skip flag of the table 6 is “1”.

Thus, the cache data in the tables 1-5, 7 and 8 are positively backed up to the NAND flash 201a and the cache data in the table 6 is not backed up.

If a staging process begins, a table of the cache 201b corresponding to the Skip flag of 1 is preferably used as a data area for read-data. If no table corresponding to the Skip flag of 1 exists, when a data area in which read-data is stored is secured, a Skip flag corresponding to the secured area is made 1.

Then, the TBM 213b illustrated in FIG. 5 will be explained. The TBM 213b is a table which manages a bad block in which a writing failure (Program Fail), an erasing failure (Erace Fail) or a reading failure (Load Fail) occurs, and corresponds to the InvalidTable described above. Each data is managed by means of firmware of the RoC 201d.

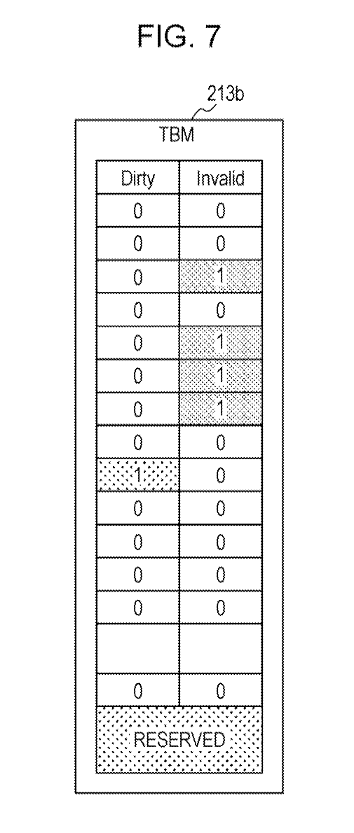

That will be specifically explained with reference to the drawing. FIG. 7 illustrates an example of a data structure in the TBM illustrated by the second embodiment. The TBM 213b has “Dirty” and “Invalid” columns.

The Dirty column indicates a case described above where a transfer error of the user data has occurred at the time of the backup and a writing process into the NAND flash 201a has not normally finished.

Flags of 0 or 1 are stored in the Dirty column illustrated in FIG. 7. A flag 1 standing as illustrated in FIG. 7 indicates a Dirty state, and a flag 0 indicates a case where the user data transfer has normally finished.

Such a flag stored in the Dirty column of the TBM 213b is called a Dirty flag hereafter. The cache data whose Dirty flag corresponds to 1 is periodically written to the HDD 203a, etc. by the RoC 201d.

The “Invalid” column indicates that a block of the individual NAND flash 201a is a “bad block”. Thus, that indicates an area which cannot be used for a backup of the cache data. Incidentally, a flag stored in the Invalid column of the TBM 213b is called a bad block flag hereafter.

Then, a correspondence relationship between the bad block flag and the NAND flash 201a will be explained with reference to FIG. 3. To begin with, a bad block corresponding to the block 1 is “0” stored at a highest rank in the TBM 213b.

Bad block flags stored in the TBM 213b similarly and individually correspond to the block 2 and the following blocks. Thus, the bad block flags of the blocks 2 and 4 are “0”, and the bad block flags of the blocks 3 and 5-7 are “1”.

As the Dirty flag corresponding to the block 9 is “1”, it indicates that, when cache data is written to the block 9, a transfer error of the cache data has occurred. Meanwhile, the Dirty flags of the blocks except for the block 9 are “0”, they indicate that the process for writing the cache data has normally finished.

Return to the explanation referring to FIG. 5, and the TRN 214 will be explained. The TRN 214 indicates a DMA to which user data in the cache 201d is evacuated. The TRN 214 has a main controller 214a, a read section 214b, an error controller 214c, a buffering section 214d and a NAND write controller 214e.

The main controller 214a is a processing section which manages addresses in the TBM 213b and updates the bad block flags and the Dirty flags stored in the TBM 213b. The main controller 214a requests the read section 214b to start to read data from the cache 201b in case of a power failure.

The read section 214b is a controller which reads cache data from the cache 201b in case of a power failure, identifies whether the read cache data is to be evacuated to the NAND flash 201a by using the skip flag, and provides the error controller 214c and the buffering section 214d with particular cache data.

The read section 214b has a flag identifying section 220, a cache address managing section 221 and a read controller 222.

The flag identifying section 220 refers to the Skip management table 213a, identifies whether the cache data obtained by the read section 214b is to be evacuated to the NAND flash 210a by using the skip flag that has been referred to, and provides the read controller 222 with an identified result.

If, e.g., the skip flag that has been referred to is 0, the flag identifying section 220 identifies the cache data obtained by the read section 214b as the cache data which is to be evacuated to the NAND flash 201a. Meanwhile, if the skip flag that has been referred to is 1, the flag identifying section 220 identifies the cache data obtained by the read section 214b as the cache data which is not to be evacuated to the NAND flash 201a.

The cache address managing section 221 is a processing section which manages a cache address indicating a position of cache data in the cache 201b, and provides the flag identifying section 220 with the managed cache address.

The respective tables included in the cache 201b are identified by means of the cache address described above, and the cache data is temporarily stored in a proper one of the tables.

The read controller 222 provides the error controller 214c and the buffering section 214d with the cache data that the flag identifying section 220 has identified as the cache data which is evacuated to the NAND flash 201a. An evacuating unit evacuates the data stored in the first memory to the second memory in reference to the table when the second power supply unit is supplying electronic power to the storage system.

In case of a transfer error, the error controller 214c notifies the main controller 214a of an address for identifying a NAND block in which the transfer error has occurred, and asks to update the Dirty flag in the TBM 213b.

The buffering section 214d performs an XOR (exclusive logical sum) operation so as to prevent the cache data provided by the read controller 222 from changing itself, creates parity data and adds XOR parity data to the cache data.

Further, the buffering section 214d adds redundant bits formed by CRC (Cyclical Redundancy Check) and AID (AreaID) to the user data, has a buffer for keeping the user data to which the redundant bits are added, and provides the NAND write controller 214e with the user data stored in the buffer.

The NAND write controller 214e has an address for identifying each of the blocks of the NAND flash 201a, and further, provides the NAND flash 201a through the IF controller 215 with the user data input from the buffering section 214d so as to write the user data.

Further, when the NAND write controller 214e writes the cache data to the NAND flash 201a, if a transfer error occurs and the NAND write controller 214e fails to write the cache data, the NAND write controller 214e provides the error controller 214c with identification data of a corresponding block.

The IF controller 215 is an interface which controls an exchange of various data between the TRN 214 and the NAND flash 201a.

Then, a process that the RAID device 200 performs in case of a power failure by using the cache 201b, the Skip management table 213a, the TBM 213b and the NAND flash 201a explained so far will be explained with reference to the drawings.

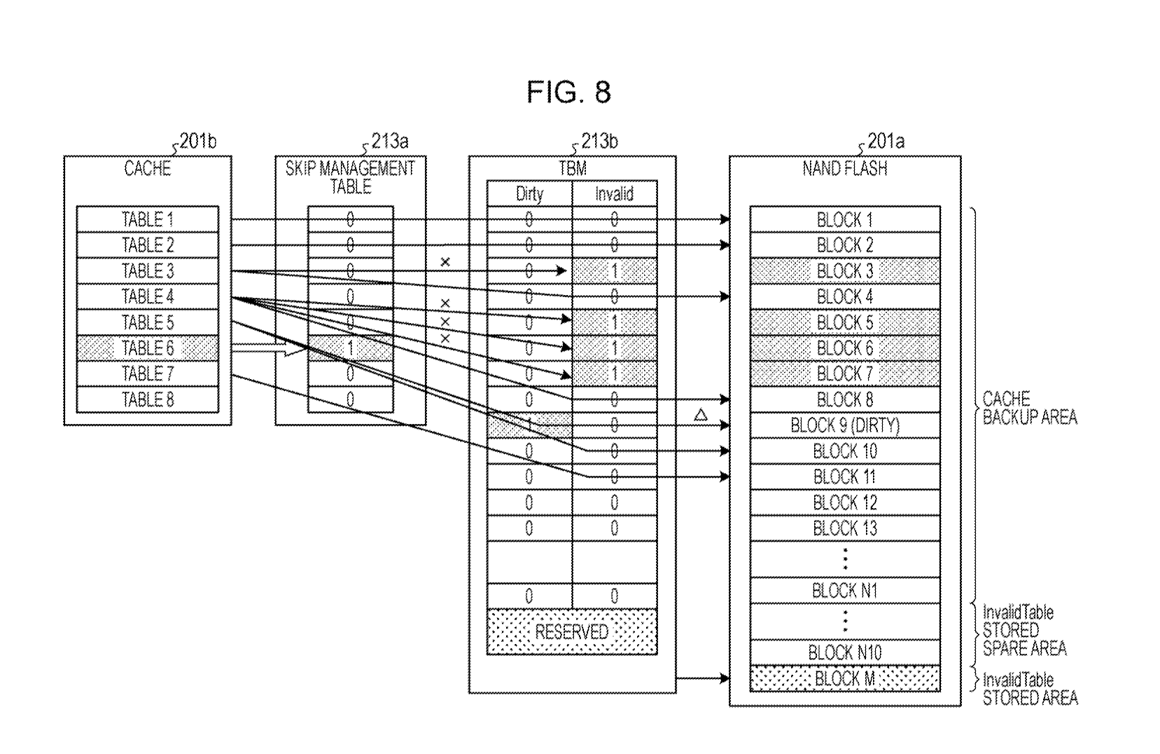

FIG. 8 illustrates a backup process. To begin with, the cache 201b has tables 1-8 as tables in which user data is stored similarly as in FIG. 4. Assume that read-data is stored in the table 6, and write-data is stored in the respective tables except for the table 6.

Skip flags are stored in the Skip management table 213a by means of the firmware of the RoC 201d on the basis of the cache data stored in the tables 1-8. In this case, the skip flag corresponding to the table 6 is “1”, and the skip flags corresponding to the respective tables except for the table 6 are “0”.

Then, assume that the FPGA 201c illustrated in FIG. 5 manages the Dirty and Invalid flags corresponding to the respective blocks in the NAND flash on the basis of the TBM 213b.

Then, if a power failure occurs in the case described above, the TRN 214 receives an instruction from the RoC 201d, and writes the cache data in the cache 201b to the NAND flash 201a on the basis of the skip flag. That will be explained in detail as follows.

To begin with, the FPGA 201c reads a bad block flag corresponding to the block 1 of the NAND flash 201a from the TBM 213b, so as to obtain a bad block flag “0”.

Then, the FPGA 201c reads a skip flag corresponding to the table 1 of the cache 201b from the Skip management table 213a. In this case, as the skip flag is “0”, the cache data stored in the table 1 is written to the block 1 of the NAND flash 201a.

Then, after the TRN 214 checks that the writing process to the block 1 has finished without causing a transfer error, a backup of the cache data stored in the table 2 begins.

Then, the bad block flag “0” of the block 2 corresponding to the backup area of the table 2 is obtained from the TBM 213b, and the FPGA 201c reads a skip flag corresponding to the table 2 of the cache 201b from the Skip management table 213a.

In this case, as the skip flag is “0”, the cache data stored in the table 2 is written to the block 2 of the NAND flash 201a.

Then, after the TRN 214 checks that the writing process to the block 2 has finished without causing a transfer error, a backup of the cache data stored in the table 3 begins.

Then, the bad block flag “1” of the block 3 corresponding to the backup area of the table 3 is obtained from the TBM 213b. As being a bad block as described above, the block 3 is not used as a data area for the backup. The cache data in the table 3 is stored in one of the block 3 and the following blocks, and the block 4 becomes a candidate of the block in which the cache data is stored.

Hence, the FPGA 201c reads a bad block flag corresponding to the block 4 of the NAND flash 201a from the TBM 213b, and in this case, obtains a bad block flag “0” corresponding to the block 4 of the NAND flash 201a.

Then, the FPGA 201c reads a skip flag corresponding to the table 3 of the cache 201b from the Skip management table 213a. In this case, as the skip flag is “0”, the cache data stored in the table 3 is written to the block 4 of the NAND flash 201a.

Then, after the TRN 214 checks that the writing process to the block 4 has finished without causing a transfer error, a backup of the cache data stored in the table 4 begins.

Then, the bad block flag “1” of the block 5 corresponding to the backup area of the table 4 is obtained from the TBM 213b. As being a bad block, the block 5 is not used as a data area for the backup. The cache data in the table 4 is stored in one of the block 6 and the following blocks, and the block 6 becomes a candidate of the block in which the cache data is stored.

Hence, the FPGA 201c reads a bad block flag corresponding to the block 6 of the NAND flash 201a from the TBM 213b, and in this case, obtains a bad block flag “1” corresponding to the block 6 of the NAND flash 201a.

As the block 6 is a bad block similarly as the block 5, the FPGA 201c reads a bad block flag corresponding to the block 7 of the NAND flash 201a from the TBM 213b, and in this case, obtains a bad block flag “1” corresponding to the block 7 of the NAND flash 201a.

As the block 7 is a bad block similarly as the block 6, the FPGA 201c reads a bad block flag corresponding to the block 8 of the NAND flash 201a from the TBM 213b, and in this case, obtains a bad block flag “0” corresponding to the block 8 of the NAND flash 201a.

Then, the FPGA 201c reads a skip flag corresponding to the table 4 of the cache 201b from the Skip management table 213a. In this case, as the skip flag is “0”, the cache data stored in the table 4 is written to the block 8 of the NAND flash 201a.

Then, after the TRN 214 checks that the writing process to the block 8 has finished without causing a transfer error, a backup of the cache data stored in the table 5 begins.

Then, the bad block flag “0” of the block 9 corresponding to the backup area of the table 5 is obtained from the TBM 213b. Then, the FPGA 201c reads a skip flag corresponding to the table 5 of the cache 201b from the Skip management table 213a. In this case, as the skip flag is “0”, the cache data stored in the table 5 is written to the block 9 of the NAND flash 201a.

Assume that, when the cache data in the table 5 is written to the block 9, the TRN 214 detects a transfer error. In this case, the TRN 214 makes the Dirty flag in the TBM 213b corresponding to the block 9 “1”.

Then, a backup of the cache data stored in the table 5 begins again to the block 10. In this case, as the corresponding bad block flag is “0”, the cache data in the table 5 is written to the block 10 of the NAND flash 201a.

Incidentally, as the block 9 is not a bad block and no hardware failure occurs in the NAND flash 201a, the FPGA 201c automatically clears the cache data stored in the block 9 after a next erasing process.

Then, after the TRN 214 checks that the writing process to the block 10 has finished without causing a transfer error, a backup of the cache data stored in the table 6 begins.

Then, the bad block flag “0” of the block 11 corresponding to the backup area of the table 6 is obtained from the TBM 213b. Then, the FPGA 201c reads a skip flag corresponding to the table 6 of the cache 201b from the Skip management table 213a.

In this case, as read-data is stored in the table 6, the FPGA 201c reads “1” as the skip flag corresponding to the table 6. The TRN 214 consequently skips the backup of the cache data stored in the table 6.

Then, the process shifts to a start of a backup of the cache data stored in the table 7. In this case, the FPGA 201c reads a skip flag corresponding to the table 7. As the skip flag “0” is stored, the cache data stored in the table 7 of the cache 201b is written to the block 11 of the NAND flash 201a.

Then, after the TRN 214 checks that the writing process to the block 11 has finished without causing a transfer error, a backup of the cache data stored in the table 8 begins.

Then, the bad block flag “0” of the block 12 corresponding to the backup area of the table 8 is obtained from the TBM 213b. Then, the FPGA 201c reads a skip flag corresponding to the table 8. As the skip flag “0” is stored, the cache data stored in the table 8 of the cache 201b is written to the block 12 of the NAND flash 201a.

When the cache data is backed up to the NAND flash 201a in case of a power failure, as described above, the cache data to be backed up is identified on the basis of the skip flag and the cache data is backed up on the basis of the identified result.

Incidentally, e.g., if a processing time required for the backup is kept secured after the backup of the cache data in the table 8 of the cache 201b finishes, the read-data stored in the table 6 can also be backed up to the NAND flash 201a.

Then, return to the explanation referring to FIG. 2, and the RoC 201d will be explained. The RoC 201d is a controller which controls the whole CM 201, and is a processing section provided with firmware for performing a backup process of the cache 201b, interface control to and from the host and management of the cache 201b.

Upon receiving an instruction from the host to write user data, the RoC 201d does not make a table of the cache 201b corresponding to the skip flag 1 a data area to which the user data is written, and writes the user data to a table corresponding to the skip flag 0.

Meanwhile, upon receiving an instruction from the host to read user data, the RoC 201d uses a table of the cache 201b corresponding to the skip flag 1 as an area for read-data in which the user data is stored.

The RoC 201d secures a data area for read-data for the staging process. If the cache 201b has no table corresponding to the skip flag 1, the RoC 201d makes a certain table a data area for read-data and sets the corresponding skip flag to 1.

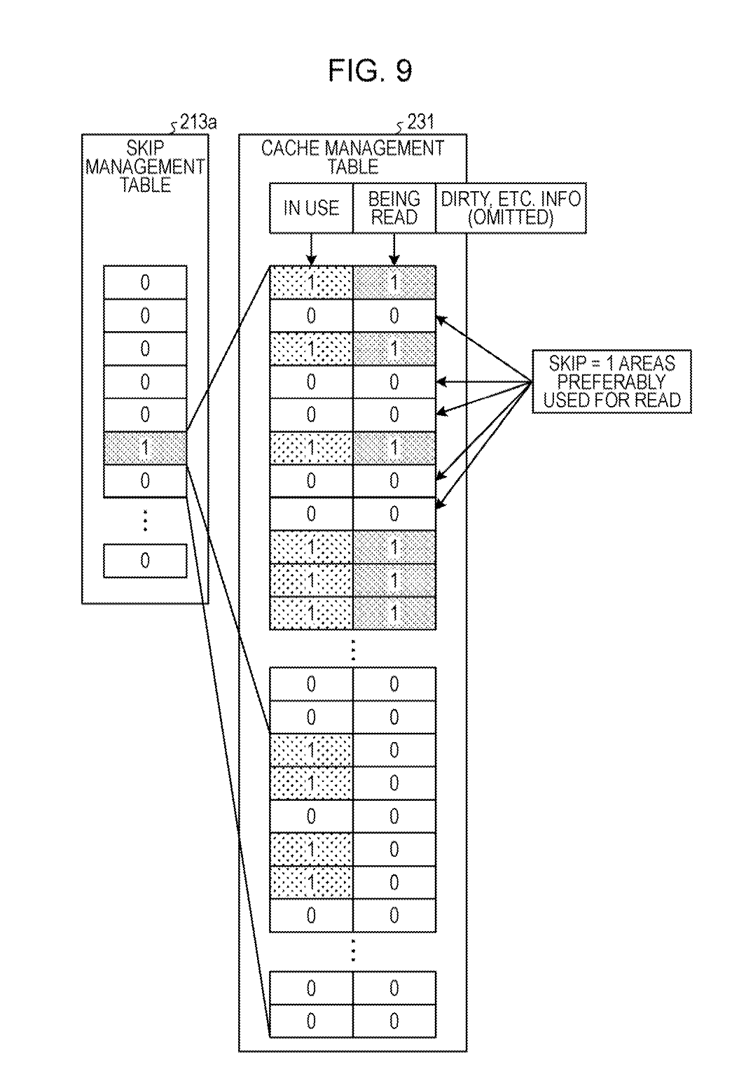

Then, the management of the cache 201b performed by the RoC 201d will be explained with reference to the drawings. FIG. 9 illustrates the process of the RoC of the second embodiment. A cache management table 231 illustrated in FIG. 9 is a table that the firmware of the RoC 201d uses for managing the cache 201b.

Assume, e.g., that a plurality of upper devices (e.g., hosts A, B and C) requests IO connections and the hosts A, B and C access the RAID device 200.

In this case, e.g., if the table 6 of the cache 201b is used as an area for read-data, the skip flag corresponding to the table 6 is “1”. Then, the data area used for the table 6 is managed in detail by means of the cache management table 231.

In this case, “in use” indicates whether one of the hosts A, B and C uses the table of the cache 201b corresponding to the skip flag 1 as an area for read-data.

As illustrated in FIG. 9, e.g., the table 6 of the cache 201b is used as the area for read-data and the flag stored in “in use” is 1. Further, “being read” indicates a state in which one of the hosts A, B and C is reading read-data from the cache 201b.

Then, if the hosts A, B and C finish the use of the table 6 of the cache 201b, the firmware of the RoC 201d releases the skip flag “1” stored in the Skip management table 213a.

Then, return to the explanation referring to FIG. 2, and the SCU (Super Capacitor Unit) 201e will be explained. The SCU 201e is a capacitor of large capacity, and supplies the RoC 201d with power in a battery-free manner in a case where a power failure occurs in the RAID device 200. As charged power is supplied, the supplied power is limited differently from the PSU 202.

The SCU 201e uses an “electric double layer” (put an insulator between conductors and apply voltage so that electric charges accumulate) capacitor which physically accumulates electric charges. Thus, the SCU 201e is not so degraded by charging and discharging as a battery which chemically accumulates electricity is, and is charged at moving speed of electric charges.

The EXP (expander) 201f is a processing section which relays user data exchanged between the RoC 201d and the HDDs 203a-203z.

The PSU (Power Supply Unit) 202 is a device which supplies the RAID device 200 with power, and stops supplying the RAID device 200 with power in case of a power failure. In this case, as described above, the RAID device 200 is supplied with power by means of discharging of the SCU 201e.

The HDDs 203a-203z form a RAID group, and data is distributed to them in accordance with levels of high-speed performance and safety. They have storage media (disks), etc. to which user data is written and in which programs are stored.

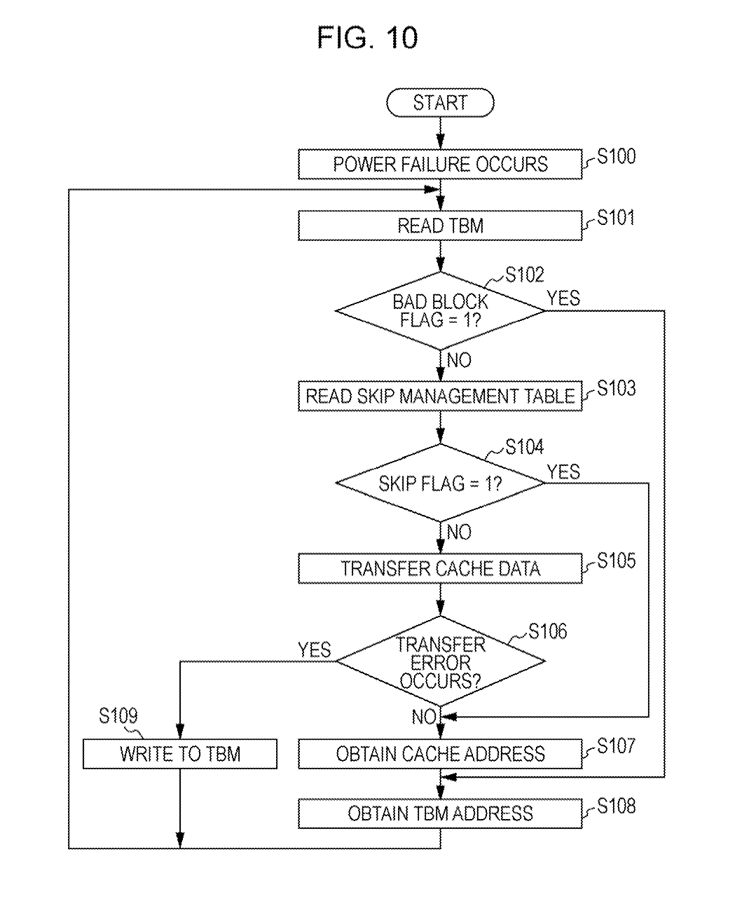

Then, the process performed by the RAID device 200 illustrated by the second embodiment in case of a power failure will be explained. FIG. 10 is a flowchart for illustrating the process in case of a power failure.

A power failure occurs in the RAID device 200, first, and the power supply to the RoC 201d changes over from the PSU 202 to the SCU 201e (step S100). Then, upon being instructed by the RoC 201d, the TRN 214 reads the TBM 213b (step S101).

Then, if the bad block flag of the block to be backed up is not 1 (step S102, No), the TRN 214 reads the Skip management table 213a (step S103).

In this case, if the skip flag is not 1 (step S104, No), cache data corresponding to the skip flag 1 is transferred to the NAND flash 201a (step S105).

Then, if no transfer error occurs for the cache data transferred at the step S105 (step S106, No), cache data stored in an address next to the cache data transferred at the step S105 is obtained (step S107).

Then, an address corresponding to a block next to the block of the NAND flash 201a read at the step S 101 in an ascending order is obtained (step S108).

Incidentally, if the TRN 214 reads the TBM 213b corresponding to the cache 201b at the step 101 and the bad block flag of the TBM 213b is 1 (step S102, Yes), shift to the step S108.

Further, if a transfer error occurs (step S106, Yes), change the Dirty flag of the TBM 213b from 0 to 1 (step S109).

According to the flowchart, when the cache data is backed up to the NAND flash 201a in case of a power failure, cache data to be backed up is identified on the basis of the skip flag and particular cache data is backed up, a period of time required for backing the cache data up can be reduced.

Then the process performed by the RAID device 200 of the second embodiment will be explained. To begin with, the RAID device 200 receives a request for an IO (Input/Output: access) connection (step S200). Then, the RAID device 200 provides the host with a reply to the request for the IO connection (step S201).

Then, the host requests the RAID device 200 to read user data (step S202). Then, the RAID device 200 receives a disk address transmitted by the host (step S203).

Then, the RAID device 200 searches the cache data in the cache 201b on the basis of the disk address received at the step S203 (step S204). If the read-data requested by the host can be obtained from the cache 201b (step S205, Yes), shift to a step S214.

Meanwhile, if no read-data is obtained from the cache 201b (step S205, No), the RAID device 200 secures a data area in which read-data corresponding to the step S202 is stored in the cache 201b (step S206), and starts the staging process (step S207).

At this time, the skip flag corresponding to the table of the cache 201b is made 1. Then, the RAID device 200 obtains the user data corresponding to the read-data from the HDDs 203a-203z (step S208).

Then, the RAID device 200 copies the user data obtained at the step S208 into the cache 201b, and finishes the staging process (step S209).

Then, the RAID device 200 notifies the host of being ready for the IO connection (step S210). Then, the RAID device 200 receives a reading request from the host again (step S211), and further receives a disk address (step S212).

Then, the RAID device 200 searches the cache 201b for the cache data corresponding to the reading request on the basis of the disk address received at the step S212 (step S213). Then, the RAID device 200 obtains the cache data corresponding to the user data obtained at the step S208, and replies to the reading request received at the step S211 (step S214).

Then, the host requests the RAID device 200 to read read-data (step S215). Upon receiving the reading request, the RAID device 200 transmits the cache data obtained at the step S213 to the host (step S216).

Then, unless another host uses the cache area of the cache 201b secured at the step S206, the RAID device 200 releases the skip flag (step S217).

According to the second embodiment, as described so far, as cache data to be backed up is identified on the basis of the skip flag and proper cache data is backed up, a period of time required for backing the cache data up can be reduced.

The disclosed evacuation processing device has an effect of reducing processing time required for backing a cache memory up in case of a power failure and increasing a backup speed.

As mentioned above, the present invention has been specifically described for better understanding of the embodiments thereof and the above description does not limit other aspects of the invention. Therefore, the present invention can be altered and modified in a variety of ways without departing from the gist and scope thereof.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A storage system comprising:
a first power supply unit for supplying electronic power to the storage system;
a second power supply unit for supplying electronic power to the storage system when the first power supply unit is not supplying electronic power to the storage system;
a storage for storing data;
a first memory for storing data;
a control unit for reading out data stored in the storage and writing the data into the first memory, and reading out data stored in the first memory and writing the data into the storage;
a second memory for storing data stored in the first memory;
a table memory for storing a table indicating whether each of the data stored in the first memory is to be evacuated to the second memory or not, respectively; and
an evacuating unit for evacuating the data stored in the first memory to the second memory in reference to the table when the second power supply unit is supplying electronic power to the storage system.

2. The storage system of claim 1, wherein the table manages write data to be written into the storage and read data read out from the storage.

3. The storage system of claim 2, wherein the evacuating unit evacuates the write data in reference to the table.

4. The storage system of claim 1, wherein the second memory is capable of maintaining the data after termination of supplying electric power by the first power supply unit and the second power supply unit.

5. An evacuation processing device comprising:
a first memory for storing data;
a second memory for storing data stored in the first memory;
a table indicating whether each of the data stored in the first memory is to be evacuated to the second memory or not, respectively; and
an evacuating unit for evacuating the data stored in the first memory to the second memory in reference to the table in case of a power failure.

6. The evacuation processing device of claim 5, wherein the table manages write data to be written into a storage and read data read out from the storage.

7. The evacuation processing device of claim 6, wherein the evacuating unit evacuates the write data in reference to the table.

8. The evacuation processing device of claim 5, wherein the second memory is capable of maintaining the data in case of a power failure.

9. A method of controlling an evacuation processing device, comprising:
storing data into a first memory;
storing data stored in the first memory into a second memory; and
evacuating the data stored in the first memory to the second memory in reference to a table indicating whether each of the data stored in the first memory is to be evacuated to the second memory or not, respectively in case of a power failure.

10. The method of claim 9, wherein the table manages write data to be written into a storage and read data read out from the storage and the evacuating evacuates the write data in reference to the table.
